(19) United States
(12) Patent Application Publication
(10) Pub. No.: US 2024/0191841 A1
(43) Pub. Date: Jun. 13, 2024

(54) TEMPERATURE CONTROL DEVICE FOR LIQUID HYDROGEN STORAGE TANK, AND LIQUID HYDROGEN STORAGE SYSTEM USING SAME

(71) Applicant: KOREA INSTITUTE OF MACHINERY & MATERIALS, Daejeon (KR)

(72) Inventors: Hwa Long YOU, Busan (KR); Tae Hoon KIM, Daejeon (KR); Kyu Hyung DO, Daejeon (KR); Byung Il CHOI, Daejeon (KR); Ae Jung YOON, Daejeon (KR)

(21) Appl. No.: 18/550,607

(22) PCT Filed: Nov. 26, 2021
(86) PCT No.: PCT/KR2021/017664

§ 371 Date: Nov. 9, 2023

(30) Foreign Application Priority Data
Nov. 27, 2020 (KR) 10-2020-0162578

(51) Int. Cl. F17C 13/02; B01J 23/745; B01J 35/40; B01J 35/64; F17C 1/00

(52) U.S. Cl. CPC F17C 13/026; B01J 23/745; B01J 35/40; B01J 35/64; F17C 1/002; F17C 2221/012; F17C 2250/03; F17C 2250/0491; F17C 2250/0631; F17C 2260/056

(57) ABSTRACT

Provided is a liquid hydrogen storage system including: a hydrogen storage tank coupled to a vessel hull and configured to store liquid hydrogen; a catalyst for conversion of para hydrogen in the liquid hydrogen into ortho hydrogen; and a catalyst holder disposed at an upper portion of the hydrogen storage tank and configured to hold the catalyst. A catalytic reaction to convert the para hydrogen into the ortho hydrogen occurs as the temperature of the upper portion of the hydrogen storage tank increases.

### TECHNICAL FIELD

The present disclosure relates to a temperature control device for a liquid hydrogen storage tank and a liquid hydrogen storage system using the same, and more particularly, to a temperature control device for a liquid hydrogen storage tank, which induces a catalytic reaction to convert para hydrogen into ortho hydrogen according to a change in internal temperature of a hydrogen storage tank in which liquid hydrogen is stored, and a liquid hydrogen storage system using the same.

### BACKGROUND ART

Recently, energy demand has been continuously increased due to the rapid development of industrialization and the increase in population. Accordingly, the supply of alternative energy is urgently needed due to the depletion of fossil fuels.

In particular, in the case of Korea, energy consumption is so large that Korea ranks among the top 10 in the world, but Korea relies on foreign imports for more than 90% of energy used. Therefore, measures to secure energy are urgently needed.

In this regard, hydrogen is considered as an alternative energy source that is attracting attention to solve complex energy problems that the world is facing.

Hydrogen is the most abundant element on the earth after carbon and nitrogen and is also a clean energy source that produces only a very small amount of nitrogen oxides during combustion and does not emit any other pollutants. Hydrogen may be produced by using the abundant amount of water existing on the earth as a raw material. Also, hydrogen is recycled back into water after use. Therefore, hydrogen may be said to be an optimal alternative energy source with no fear of depletion.

In order to use hydrogen as an energy source, simplicity of transportation and ease of storage have to be guaranteed. To this end, it is necessary to reduce the volume of hydrogen through densification. Among the known methods of storing hydrogen by reducing the volume of hydrogen, a method of liquefying hydrogen and storing hydrogen in the form of liquid hydrogen has the highest storage energy.

Hydrogen has a unique characteristic in that the ratio of ortho hydrogen to para hydrogen is 3:1 at room temperature (300 K). When hydrogen is cooled for liquefaction, hydrogen exists as liquid hydrogen in a range of 14 K to 20 K depending on a critical temperature and a triple point. The ratio of ortho hydrogen to para hydrogen at 20 K unlike room temperature (300 K) is about 0.2:99.8, and liquid hydrogen evaporates due to latent heat generated when converted to this ratio.

However, liquid hydrogen has a liquefaction temperature of −253° C. (20.15 K), which is lower than a liquefaction temperature (−162° C.) of cryogenic liquefied natural gas (LNG). Accordingly, liquid hydrogen evaporates more easily than LNG, and the boil-off rate (BOR) of liquid hydrogen per volume is ten times the BOR of LNG.

On the other hand, regarding the method of transporting these energy sources, an existing LNG carrier unloads LNG at a LNG import/export terminal and then returns back to an LNG terminal and loads LNG. During a certain period of ballast voyage, an LNG storage tank is cooled down by using the remaining LNG for the following purposes (see FIG. 1).

In order to enter an LNG terminal (production base), certain conditions have to be satisfied. First, (top+bottom)/2≤−130° C., which is an average temperature of the mean top and bottom condition in LNG tank (ATR) criterion, has to be satisfied, and the prevention of damage to cargo tanks due to thermal stress, the suppression of excessive BOG generation during loading, and the suppression of excessive BOG generation after departure are required.

An LH2 tanker is a vessel that transports liquid hydrogen, similar to LNG. The LH2 tanker handles cargo having a temperature of −253° C. (20.15 K), which is lower than a temperature of LNG. The LH2 tanker is in the infancy stage of technology worldwide and the related laws and regulations such as LH2 terminals are lacking, but cool-down is required for the same purpose as the LNG carrier during ballast voyage.

An existing cool-down method uses a method of cooling cargo by spraying into the tank through a nozzle by using a spray pump installed at a lower portion of a storage tank with about 5% of cargo left. In other words, the spray pump installed at the lower portion of the cargo storage tank is operated to cool the inside of the tank to below a target temperature through the nozzle installed at the upper end of the tank.

However, the spray pump has to take into account the matters such as i) adjustment of spray pump load to match a nozzle inlet pressure level, ii) increased BOG due to heat intrusion when the amount of cargo recirculation is large, iii) low current trip, iv) adjustment of spray pump load according to hull motion. Accordingly, there are operational problems that require careful attention.

Therefore, there is a need to develop a method capable of simplifying existing difficult operation procedures and efficiently maintaining a temperature of a storage tank by using characteristics of liquid hydrogen.

### DISCLOSURE

### Technical Problem

Therefore, an objective to be achieved by the present disclosure is to provide a temperature control device for a liquid hydrogen storage tank, which is capable of maintaining the inside of the liquid hydrogen storage tank at a low temperature through an endothermic reaction of para-to-ortho hydrogen conversion using a catalyst.

Furthermore, the present disclosure aims to provide a liquid hydrogen storage system capable of controlling an internal temperature of a liquid hydrogen storage tank according to the internal temperature and ortho-para fraction of the liquid hydrogen storage tank.

On the other hand, the objectives of the present disclosure are not limited to those described above, and other objectives that are not mentioned herein will be clearly understood from the following description by those of ordinary skill in the art. Technical Solution

According to an aspect of the present disclosure, a temperature control device for a liquid hydrogen storage tank, which is provided at an inner upper portion of a hydrogen storage tank in which liquid hydrogen is stored, may include: a catalyst for conversion of para hydrogen into ortho hydrogen in the liquid hydrogen; and a catalyst holder disposed at an upper portion of the hydrogen storage tank and configured to hold the catalyst, wherein a catalytic reaction to convert the para hydrogen into the ortho hydrogen according to a change in an internal temperature of the hydrogen storage tank may be induced.

The catalyst holder may be further configured to adjust an exposure area of the catalyst according to the change in the internal temperature of the hydrogen storage tank.

The catalyst holder is further configured such that as the internal temperature of the hydrogen storage tank increases, the exposure area of the catalyst may be increased so as to promote the catalytic reaction to convert the para hydrogen into the ortho hydrogen.

The catalyst holder may be formed to surround at least a portion of the catalyst, may include a plurality of pores formed to expose the catalyst to an outside, and may be formed of a shape memory alloy whose pore size is adjusted according to the internal temperature of the hydrogen storage tank.

The catalyst holder may include: a porous member formed to surround at least a portion of the catalyst and including a plurality of pores formed to expose the catalyst to the outside; and an opening/closing portion provided to surround an outside of the porous member and configured to operate to vary an area where the catalyst comes into contact with the outside according to the internal temperature of the hydrogen storage tank.

The opening/closing portion may be formed of a shape memory alloy or a structure that is driven by an electric signal.

A size of the pore may be smaller than a particle size of the catalyst.

The catalyst may be iron oxide.

According to an aspect of the present disclosure, a liquid hydrogen storage system may include: the temperature control device; a temperature sensor configured to measure the internal temperature of the hydrogen storage tank; a fraction analyzer configured to measure a para-ortho hydrogen fraction in the hydrogen storage tank; and a controller configured to receive internal temperature and ortho-para fraction information of the hydrogen storage tank from the temperature sensor and the fraction analyzer and control the operation of the catalyst holder to adjust a contact area between the hydrogen and the catalyst.

The temperature control device may be the temperature control device according to an embodiment of the present disclosure.

The temperature sensor may include a plurality of temperature sensors spaced apart from each other by a certain distance in a height direction of the hydrogen storage tank, and the controller may be further configured to adjust the contact area of the catalyst so that an average temperature in the height direction of the hydrogen storage tank is maintained at 14 K to 80 K.

The liquid hydrogen storage system may be installed in a vessel on which a hydrogen storage tank storing liquid hydrogen is mounted, and the controller may be further configured to receive, from an operation system of the vessel, operation information including at least one of a number of days of ballast voyage, an average temperature of a mean top and bottom condition in liquefied natural gas (LNG) tank (ATR), an amount of fuel supply to a fuel cell, and a vent amount of hydrogen gas and adjust the contact area of the catalyst.

### Advantageous Effects

An existing method of cooling a storage tank had a disadvantage in that availability is low due to frequent breakdowns caused by the operations of pumps and additional heat generated by the operations of pumps entered a tank. However, according to an embodiment of the present disclosure, a pump is removed, and thus, a tank may be maintained at a low temperature in a simple manner.

In addition, according to an embodiment of the present disclosure, there is an advantage in that efficient liquid hydrogen cargo management is possible by allowing a driver to actively control a temperature of a storage tank according to the conditions of his/her vessel.

On the other hand, the effects described above are merely illustrative, and effects predicted or expected from the detailed configuration of the present disclosure from the perspective of those of ordinary skill in the art may also be added to the unique effects of the present disclosure.

### DESCRIPTION OF DRAWINGS

FIG. 1 is a diagram illustrating an existing liquid hydrogen value chain and a method of cooling a storage tank during ballast voyage.

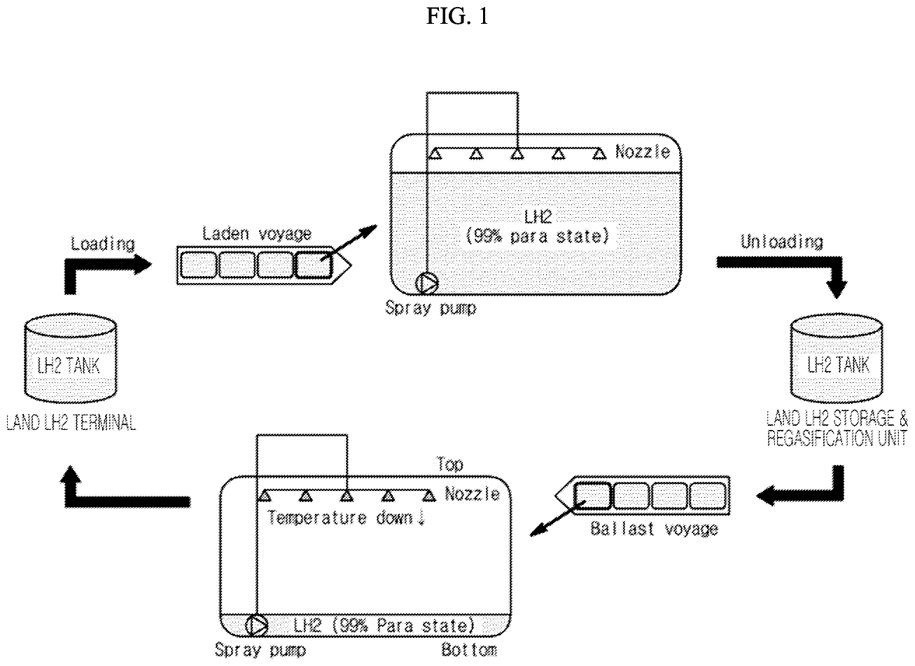

FIG. 2 is a diagram illustrating energy levels of para hydrogen and ortho hydrogen, and

FIG. 3 is a diagram illustrating an equilibrium fraction of ortho hydrogen according to a temperature.

FIG. 4 is a diagram illustrating a conversion time from an ortho state to a para state in the absence of a catalyst.

FIG. 5 is a diagram illustrating a liquid hydrogen storage system according to an embodiment of the present disclosure, and

FIG. 6 is a diagram illustrating a change in internal temperature according to a height of a hydrogen storage tank after a certain voyage.

FIG. 7 is a diagram illustrating a liquid hydrogen storage system according to an embodiment of the present disclosure.

### BEST MODE

Hereinafter, embodiments of the present disclosure are described in detail with reference to the accompanying drawings. Regardless of the reference symbols, the same or similar components are denoted by the same reference numerals, and redundant descriptions thereof are omitted. In describing embodiments disclosed in the present specification, when the detailed description of the relevant known technology is determined to unnecessarily obscure the gist of the embodiments disclosed in the present specification, the detailed description thereof is omitted herein. In addition, the accompanying drawings are only used to help easily understanding embodiments disclosed in the present specification, and the technical idea disclosed in the present specification is not limited by the accompanying drawings. It will be understood that the present disclosure includes all modifications, equivalents, and substitutes falling within the spirit and scope of the present disclosure.

It will be understood that although the terms “first,” “second,” etc. may be used herein to describe various elements, these elements should not be limited by these terms. These terms are only used to distinguish one element from another.

It will be understood that when an element is “connected” or “coupled” to another element, the element may be directly connected or coupled to the other element or may be connected or coupled to the other element with an intervening element therebetween. On the other hand, it will be understood when an element is “directly connected” or “directly coupled” to another element, no intervening element is present therebetween.

The singular forms as used herein are intended to include the plural forms as well unless the context clearly indicates otherwise.

The terms “comprise,” “include,” or “have” as used in the present specification are inclusive and therefore specify the presence of one or more stated features, integers, steps, operations, elements, components, or any combination thereof, but do not preclude the presence or addition of one or more other features, integers, steps, operations, elements, components, or any combination thereof.

In the present specification, ortho hydrogen refers to hydrogen in which two atoms constituting a hydrogen molecule have the same spin directions.

In the present specification, para hydrogen refers to hydrogen in which two atoms constituting a hydrogen molecule have opposite spin directions.

In the present specification, converting ortho hydrogen into para hydrogen means changing one of the same spin directions of the two atoms of the ortho hydrogen to an opposite spin direction (spin conversion). For example, it is known that ortho hydrogen may be converted into para hydrogen by a change in magnetic force, etc. around hydrogen molecules.

In the present specification, a catalyst refers to a material that enables para hydrogen to be converted into ortho hydrogen.

Although the present disclosure has been illustrated and described in detail in the drawings and the foregoing description, the present disclosure is to be considered illustrative in nature and not restrictive. Only certain embodiments have been illustrated and described, and it will be understood that all changes and modifications falling within the spirit of the present disclosure are preferably protected.

According to an embodiment of the present disclosure, a system for storing liquid hydrogen through an endothermic reaction of para-to-ortho hydrogen conversion using a catalyst is provided. Referring to a hydrogen isomerization reaction represented by Formula 1 below, the inside of a hydrogen storage tank in which liquid hydrogen is stored may be maintained at a low temperature by using a reverse reaction of an exothermic reaction that occurs during hydrogen liquefaction. The inside of the hydrogen storage tank in which liquid hydrogen is stored may be maintained at a desirable temperature from a liquid level of hydrogen level to an upper portion of the hydrogen storage tank. An average temperature in the height direction of the hydrogen storage tank may be maintained at about 14 K (the liquid level of the liquid hydrogen) to about 80 K (the upper portion of the tank).

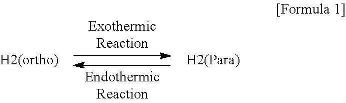

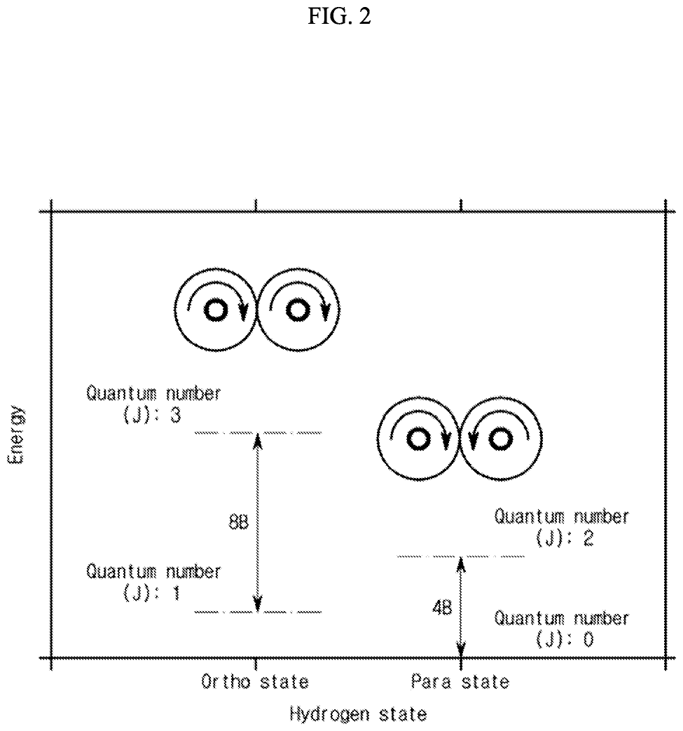

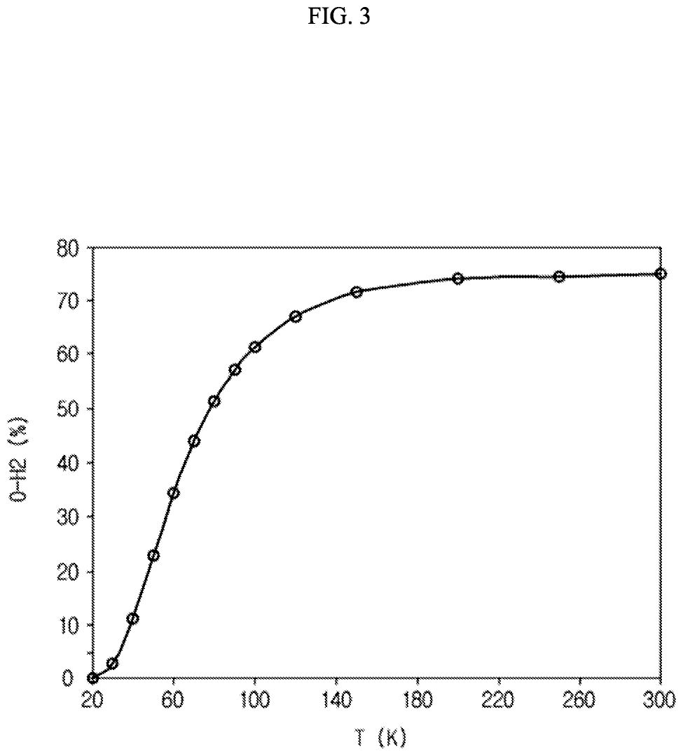

Hydrogen exists as isomers of a para state and an ortho state due to intrinsic properties thereof, and an equilibrium fraction of hydrogen varies depending on a temperature. Para hydrogen and ortho hydrogen exist in a ratio of 1:3 at room temperature (300 K), but about 97% or more of para hydrogen exists at 14 K to 20 K, which is the temperature of liquid hydrogen. FIG. 2 illustrates energy levels of para hydrogen and ortho hydrogen, and FIG. 3 illustrates an equilibrium fraction of ortho hydrogen according to a temperature. 75% of ortho hydrogen exists in a room temperature range, but as the temperature decreases, ortho hydrogen is converted into para hydrogen. FIG. 3 is a graph showing the equilibrium fraction of ortho hydrogen in the corresponding temperature range.

para H₂=(100−ortho H₂)

Referring to FIG. 2, because the energy level of the ortho state is higher than the energy level of the para state, the process of converting from ortho hydrogen to para hydrogen is an exothermic reaction and the opposite process is an endothermic reaction. Therefore, according to the present disclosure, the average temperature inside the hydrogen storage tank may be maintained at 14 K to 80 K in the height direction from the bottom to the top of the hydrogen storage tank through the endothermic reaction in which para hydrogen is converted into ortho hydrogen.

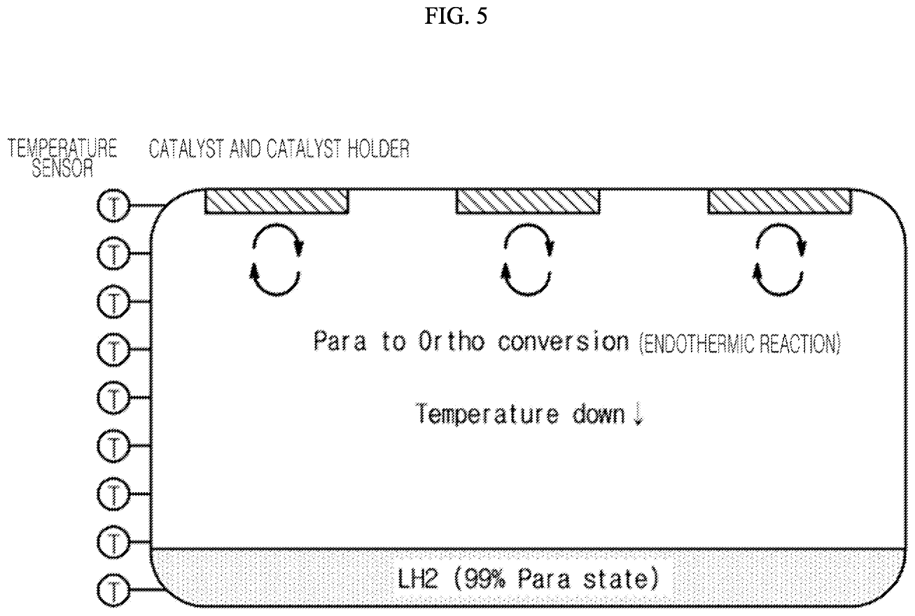

FIG. 5 illustrates a temperature control device for a liquid hydrogen storage tank according to an embodiment of the present disclosure. According to an embodiment of the present disclosure, a temperature control device for a liquid hydrogen storage tank, which is provided at an inner upper portion of a hydrogen storage tank in which liquid hydrogen is stored, includes a catalyst for conversion of para hydrogen in the liquid hydrogen into ortho hydrogen, and a catalyst holder disposed at an upper portion of the hydrogen storage tank and configured to hold the catalyst, wherein a catalytic reaction to convert the para hydrogen into the ortho hydrogen according to a change in internal temperature of the hydrogen storage tank is induced.

According to an embodiment, the hydrogen storage tank may be coupled to a hull to constitute a liquid hydrogen vessel. The liquid hydrogen vessel may be an LH2 tanker or a hydrogen fuel propulsion vessel that is propelled by using hydrogen as a fuel. In an embodiment, hydrogen used for propulsion of the hull or hydrogen for transportation may be stored in the hydrogen storage tank. In an embodiment, the hydrogen storage tank may be installed inside or outside the hull, and may be installed both inside and outside the hull.

According to an embodiment, the liquid hydrogen is stored in the hydrogen storage tank. In some cases, gaseous hydrogen may be stored in the hydrogen storage tank. The stored hydrogen may exist as isomers of a para state and an ortho state.

In the case of the LH2 tanker, 99% or more of liquid hydrogen may be stored in a para state at the time of shipment. The process of converting liquid hydrogen from the ortho state to the para state at the temperature of liquid hydrogen proceeds very slowly. Accordingly, the conversion is completed in the liquefaction process by using an iron(III) oxide (ferric oxide, Fe₂O₃)-based catalyst in the hydrogen liquefaction process and liquid hydrogen is stored in the hydrogen storage tank.

According to an embodiment, the temperature control device may be provided at the inner upper portion of the hydrogen storage tank. The temperature control device according to the present embodiment may include a catalyst and a catalyst holder configured to hold the catalyst.

The catalyst may be a catalyst for conversion of para hydrogen in the liquid hydrogen into ortho hydrogen. Such a catalyst may be, for example, iron oxide.

In addition, the catalyst holder may adjust the exposure area of the catalyst according to a change in the internal temperature of the hydrogen storage tank. For example, as the internal temperature of the hydrogen storage tank increases, the exposure area of the catalyst may be adjusted to promote the catalytic reaction to convert para hydrogen into ortho hydrogen. For example, the catalytic reaction may be promoted by increasing the exposure area of the catalyst. Alternatively, the catalytic reaction may be slowed by decreasing the exposure area of the catalyst.

The catalyst holder may be formed to surround at least a portion of the catalyst and may have a plurality of pores formed in the surface of the catalyst holder so that the catalyst is exposed to the outside. In addition, the surface of the catalyst holder may be formed of a shape memory alloy that enables a pore size to be adjusted according to a temperature.

In addition, the catalyst holder may be a porous member that is formed to surround at least a portion of the catalyst and has a plurality of pores formed in the surface of the catalyst holder so that the catalyst is exposed to the outside. In addition, the catalyst holder may include an opening/closing portion that operates electrically. The opening/closing portion may perform an opening/closing operation by using an electric signal, so that the area where the porous member is exposed to the outside is adjusted. In addition, the opening/closing portion may be formed of a shape memory alloy. In addition, the opening/closing portion may be formed of a shape memory alloy and a structure that is driven by an electric signal.

The temperature control device may be located at the inner upper portion of the storage tank. The hydrogen that is present at the lower portion of the tank exists in a liquid state and thus corresponds to a low temperature, but the hydrogen that is present at the upper portion of the tank exists in a gaseous state and thus corresponds to a relatively high temperature. Accordingly, the temperature control device may be located at the inner upper portion of the storage tank so as to convert the para state of the high-temperature gaseous hydrogen into the ortho state.

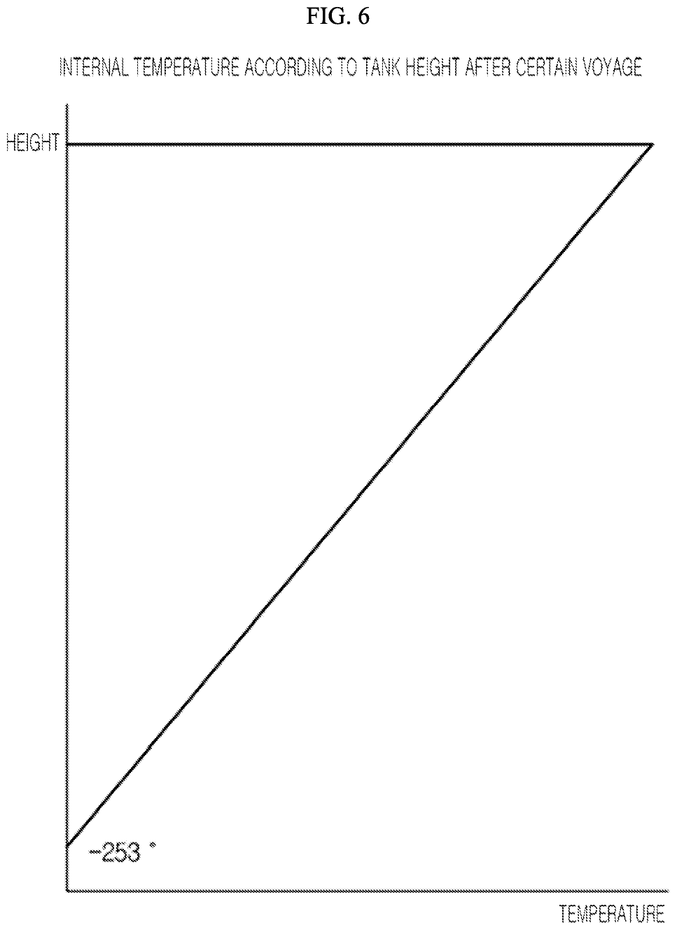

Referring to FIG. 6, as ballast voyage progresses for a certain number of days, the temperature at the upper portion of the tank increases, and thus, a temperature difference occurs between the upper portion and the lower portion of the tank. Accordingly, it is necessary to control the temperature of the upper portion of the tank. According to the present disclosure, in particular, the upper portion of the tank may be maintained at a low temperature because the temperature control device is provided at the inner upper portion of the hydrogen storage tank. The form of the temperature control device is not limited, and the concept of the temperature control device includes any mechanical devices and systems including the catalyst and the catalyst holder.

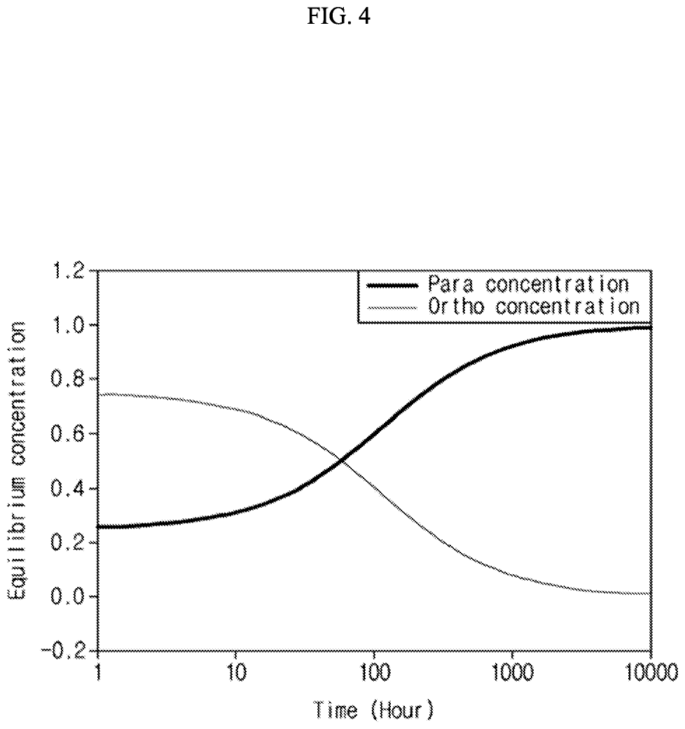

According to an embodiment, the catalyst promotes a reaction to convert para hydrogen in the liquid hydrogen into ortho hydrogen. When the temperature of the upper portion of the tank increases as the number of days of ballast voyage progresses, the process of converting from the para state to the ortho state occurs at a relatively high temperature of the upper portion of the tank according to the equilibrium fraction. In the absence of the catalyst, the process proceeds at a very slow speed (see FIG. 4). However, according to the present disclosure, because the catalyst for conversion of the para hydrogen into the ortho hydrogen is included, the catalytic reaction appropriate for the equilibrium fraction occurs automatically as the temperature of the upper portion of the hydrogen storage tank increases. The internal temperature of the storage tank may be lowered through an endothermic reaction. Therefore, by promoting the endothermic reaction to convert the para hydrogen into the ortho hydrogen through the catalyst, the average temperature inside the hydrogen storage tank may be maintained at 14 K to 80 K in the height direction of the hydrogen storage tank, which is the condition for storing liquid hydrogen.

According to an embodiment, the catalyst may be used without limitation as long as the catalyst is a material that enables the conversion of the para hydrogen into the ortho hydrogen. In an embodiment, the catalyst may use a material that shortens a para-to-ortho conversion reaction time and enables rapid conversion through a uniform particle size and a wide contact area. For example, the catalyst may be an iron oxide-based catalyst, such as FeO, Fe₃O₄, Fe₂O₃, α-Fe₂O₃, β-Fe₂O₃, γ-Fe₂O₃, or ε-Fe₂O₃.

According to an embodiment, the catalyst holder is configured to stably hold the catalyst, and the form of the catalyst is not limited. The catalyst holder may be disposed at the upper portion of the hydrogen storage tank and may effectively adjust the temperature of the upper portion of the hydrogen storage tank.

According to an embodiment, the catalyst holder may be configured so that the exposure area of the catalyst is adjustable according to a change in the internal temperature of the hydrogen storage tank. In an embodiment, as the internal temperature of the hydrogen storage tank increases, the exposure area of the catalyst may be increased so as to promote the catalytic reaction to convert the para hydrogen into the ortho hydrogen.

According to an embodiment, the catalyst holder may be formed to surround at least a portion of the catalyst, may include a plurality of pores formed so that the catalyst is exposed to the outside, and may be formed of a shape memory alloy whose pore size is adjusted according to the internal temperature of the hydrogen storage tank.

When the catalyst is held by the catalyst holder and there are no pores therein, the area where the catalyst comes into contact with gaseous hydrogen at the upper portion of the tank is reduced. Therefore, in an embodiment, the catalyst holder may include a porous member including a plurality of pores so that the catalyst may have a wide contact area with a gas phase. The catalyst may be configured to have a particle size larger than a size of the pore so that catalyst particles do not fall to the liquid level. In an embodiment, the porous member may include a plurality of pores and may be a micropore (<2 nm), a mesopore (2-50 nm), or a macropore (>50 nm). According to the present disclosure, because the catalyst holder has a porous structure, the contact surface between the catalyst and the gaseous hydrogen may be expanded, which increases the efficiency of the liquid hydrogen storage system.

According to an embodiment, the catalyst holder may include a porous member formed to surround at least a portion of the catalyst and including a plurality of pores so that the catalyst is exposed to the outside, and an opening/closing portion provided to surround the outer side of the porous member and configured to operate to vary the area where the catalyst comes into contact with the outside according to the internal temperature of the hydrogen storage tank.

The catalyst holder may include an opening/closing portion configured to operate to vary the area where the catalyst comes into contact with the outside according to the internal temperature of the hydrogen storage tank. The opening/closing portion may adjust the area where the catalyst comes into contact with the vapor state of the hydrogen storage tank. In the vapor state, gaseous hydrogen may exist in the hydrogen storage tank. The opening/closing portion may be selectively opened/closed according to a user operation so as to adjust the contact surface of the catalyst held by the catalyst holder. For example, the opening/closing portion may be installed to be movable in the left-and-right directions with respect to the catalyst holder, and may be configured in the form of a cover that surrounds the catalyst holder.

According to an embodiment, the opening/closing portion may be formed of a shape memory alloy or a structure that is driven by an electric signal. The shape memory alloy or the structure that is driven by the electric signal is a structure whose shape is changeable, and may adjust the internal temperature of the hydrogen storage tank by adjusting the contact surface between the catalyst and the hydrogen.

The shape memory alloy refers to an alloy among various metal alloys that has the property of returning to the shape before deformation when it is above the transition temperature even when deformed below the transition temperature. The transition temperature refers to a constant temperature inherent to a material when the state of the material transitions. In an embodiment, the shape memory alloy has the property of adjusting the pore size according to the internal temperature of the hydrogen storage tank.

The shape memory alloy is capable of converting thermal energy into mechanical energy (displacement, force, etc.), has characteristics such as a shape memory effect and a super elastic effect, and has excellent corrosion resistance, etc.

The shape memory effect refers to the property of deforming an object at a low temperature below the critical point and then returning to the original shape when heated to a high temperature. The super elastic effect refers to the property of deforming an object at a high temperature above the critical point (austenite) and then restoring the object to the original shape when external force is removed.

According to an embodiment, the shape memory alloy may be a nickel-based (Ni) alloy, a copper-based (Cu) alloy, an iron-based (Fe) alloy, etc. For example, the shape memory alloy may be Cu—Zn—Ni, Cu—Al—Ni, Ag—Ni, Au—Cd, etc., which are a combination of metals such as zinc (Zn), aluminum (Al), gold (Au), and silver (Ag). As another example, the shape memory alloy may be a nickel-titanium (Ni—Ti) alloy.

According to an embodiment, the structure that is driven by the electric signal may be a metal material that may change a shape by generating heat due to internal resistance of a metal when an electric signal is provided thereto. For example, the structure that is driven by the electric signal may be electrically connected to a controller, and the controller may selectively provide the electric signal to the structure that is driven by the electric signal. When an electric signal is transmitted to the structure that is driven by the electric signal, heat is generated due to electrical resistance inside the structure. This changes the internal temperature of the structure that is driven by the electric signal and ultimately changes the shape. In other words, the structure that is driven by the electric signal may change the electric signal into heat energy due to electrical resistance, and the heat energy may change the shape by changing the crystal structure of the structure that is driven by the electric signal.

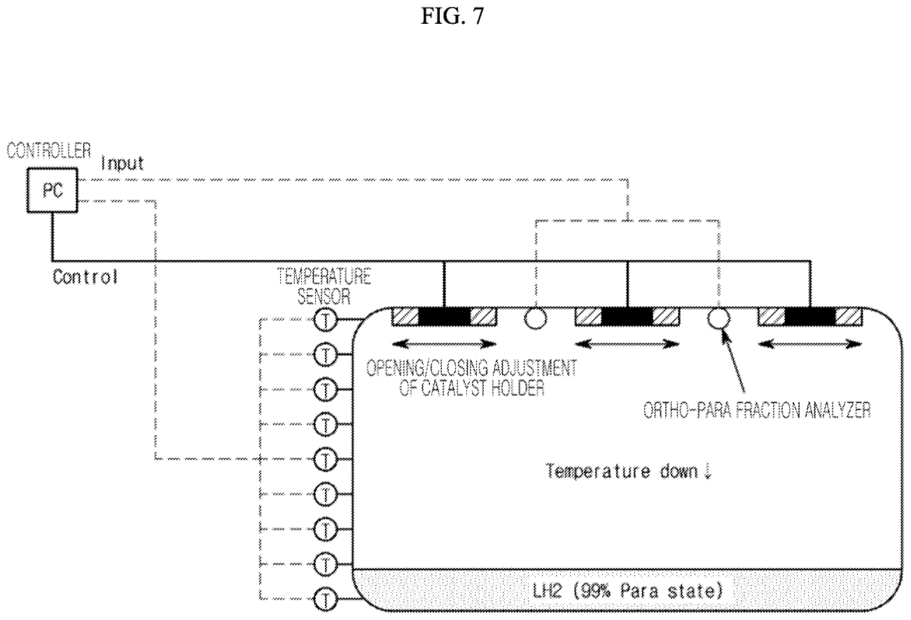

FIG. 7 illustrates a liquid hydrogen storage system according to an embodiment of the present disclosure. According to an embodiment of the present disclosure, the liquid hydrogen storage system includes a temperature control device, a temperature sensor configured to measure an internal temperature of a hydrogen storage tank, a fraction analyzer configured to measure a para-ortho hydrogen fraction of the hydrogen storage tank, and a controller configured to receive internal temperature and ortho-para fraction information of the hydrogen storage tank from the temperature sensor and the fraction analyzer and control the operation of the catalyst holder to adjust the contact area between the hydrogen and the catalyst. In an embodiment, the temperature control device may be the temperature control device according to an embodiment of the present disclosure.

According to an embodiment, the temperature sensor may include a plurality of temperature sensors spaced apart from each other by a certain distance in the height direction of the hydrogen storage tank. The temperature sensors may be installed at regular intervals according to the height of the hydrogen storage tank and may detect and measure the temperature for each height of the hydrogen storage tank. Temperature information measured by the temperature sensor is transmitted to the controller.

According to an embodiment, the ortho-para fraction analyzer may measure and analyze the isomer fractions of the ortho and para states of the hydrogen present in the hydrogen storage tank. The ortho-para fraction analyzer may be installed at an appropriate position according to the shape and size of the hydrogen storage tank. Ortho-para fraction information measured by the ortho-para fraction analyzer is transmitted to the controller.

According to an embodiment, the controller may adjust the contact area of the catalyst so that the average temperature inside the hydrogen storage tank in the height direction from the bottom to the top of the hydrogen storage tank is maintained at 14 K to 80 K.

According to an embodiment, the controller receives internal temperature and ortho-para fraction information of the hydrogen storage tank from the temperature sensor and the fraction analyzer and controls the operation of the catalyst holder to adjust the contact area between the hydrogen and the catalyst. The controller may be configured as a hydrogen storage tank temperature control system suitable for the liquid hydrogen vessel through thermodynamic calculation.

According to an embodiment, the controller may receive, from an operation system of a vessel, operation information including at least one of the number of days of ballast voyage, an average temperature of the mean top and bottom condition in LNG tank (ATR), the amount of fuel supply to the fuel cell, and the vent amount of the hydrogen gas, and may adjust the contact area of the catalyst. As the contact area with the catalyst increases, the temperature is further lowered. Considering the number of days of ballast voyage, the contact area may be adjusted according to operation conditions, such as ATR, the amount of fuel supply to the fuel cell, and the vent hydrogen amount.

The fuel cell may be used as a power source for vessel propulsion and may also be used for other electricity supply of vessels. In an embodiment, as the number of days of ballast voyage increases, the catalyst contact area may increase. In addition, when the internal temperature of the tank is higher than the ATR, the contact area may increase. In addition, as the required fuel supply increases, the contact area may decrease or there may be no contact area. In addition, when a large gas vent amount is generated, the contact area may be increased so as to control the gas vent amount. In addition, because the above variables occur simultaneously, the opening/closing amount may be adjusted in an integrated manner.

According to an embodiment, the controller may be configured to receive the temperature and fraction information from the temperature sensor and the ortho-para fraction analyzer and adjust the contact surface of the gaseous hydrogen and the catalyst so as to match the target of the vessel. In an embodiment, upon receiving the temperature and fraction information, the catalyst contact surface may be calculated by taking into account the operating conditions, and then, the catalyst contact surface may be adjusted. For example, when it is detected that the temperature at the upper portion of the hydrogen storage tank of the vessel is higher than an appropriate level, the opening/closing portion of the catalyst holder may be adjusted to expand the contact area between the hydrogen and the catalyst so as to promote the endothermic reaction and lower the temperature.

In addition, the liquid hydrogen storage system, which includes the ortho-para fraction analyzer and the temperature sensor, may maintain the target storage tank temperature by adjusting the catalytic conversion by taking into account the remaining number of days of ballast voyage and bunkering schedule.

According to an embodiment of the present disclosure, a method of storing liquid hydrogen includes converting para hydrogen into ortho hydrogen in the presence of a catalyst under conditions in which a liquid hydrogen storage system stores liquid hydrogen.

According to an embodiment, the conditions in which the liquid hydrogen is stored may be a condition in which the liquid hydrogen exists as isomers of a para state and an ortho state and the temperature of the hydrogen storage tank in which the liquid hydrogen is stored is 14 K to 80 K. For example, the ortho hydrogen and the para hydrogen may have a ratio of about 0.1:99.9 to about 25:75. As another example, the gaseous hydrogen above the liquid level of the liquid hydrogen (the upper portion of the tank) may have a ratio of about 0.1:99.9 to about 25:75, the liquid hydrogen may have a ratio of about 0.1:99.9, and the conversion between the para hydrogen and the ortho hydrogen may be freely performed according to the condition of the liquid hydrogen vessel.

Although the present embodiment has been described in detail with reference to the drawings, the scope of the present embodiment is not limited to the drawings and description.

The present disclosure is not limited to the embodiments described above, and it is obvious to those of ordinary skill in the art that various modifications and changes may be made thereto without departing from the spirit and scope of the present disclosure. Therefore, such modifications or variations should be considered to fall within the claims of the present disclosure.

1-11. (canceled)

12. A temperature control device for a liquid hydrogen storage tank, which is provided at an inner upper portion of a hydrogen storage tank in which liquid hydrogen is stored, the temperature control device comprising:
a catalyst for conversion of para hydrogen into ortho hydrogen in the liquid hydrogen; and
a catalyst holder disposed at an upper portion of the hydrogen storage tank and configured to hold the catalyst,
wherein a catalytic reaction to convert the para hydrogen into the ortho hydrogen according to a change in an internal temperature of the hydrogen storage tank is induced.

13. The temperature control device of claim 12, wherein the catalyst holder is further configured to adjust an exposure area of the catalyst according to the change in the internal temperature of the hydrogen storage tank.

14. The temperature control device of claim 13, wherein, the catalyst holder is further configured such that as the internal temperature of the hydrogen storage tank increases, the exposure area of the catalyst is increased so as to promote the catalytic reaction to convert the para hydrogen into the ortho hydrogen.

15. The temperature control device of claim 14, wherein the catalyst holder is formed to surround at least a portion of the catalyst, comprises a plurality of pores formed to expose the catalyst to an outside, and comprises a shape memory alloy whose pore size is adjusted according to the internal temperature of the hydrogen storage tank.

16. The temperature control device of claim 15, wherein a size of the pore is smaller than a particle size of the catalyst.

17. The temperature control device of claim 14, wherein the catalyst holder comprises:
a porous member formed to surround at least a portion of the catalyst and comprising a plurality of pores formed to expose the catalyst to the outside; and
an opening/closing portion provided to surround an outside of the porous member and configured to operate to vary an area where the catalyst comes into contact with the outside according to the internal temperature of the hydrogen storage tank.

18. The temperature control device of claim 17, wherein the opening/closing portion comprises a shape memory alloy or a structure that is driven by an electric signal.

19. The temperature control device of claim 17, wherein a size of the pore is smaller than a particle size of the catalyst.

20. The temperature control device of claim 12, wherein the catalyst is iron oxide.

21. A liquid hydrogen storage system comprising:
a temperature sensor configured to measure an internal temperature of a hydrogen storage tank;
a temperature control device comprising a catalyst for conversion of para hydrogen into ortho hydrogen in the liquid hydrogen and a catalyst holder configured to hold the catalyst;
a fraction analyzer configured to measure a para-ortho hydrogen fraction in the hydrogen storage tank; and
a controller configured to receive the internal temperature and the ortho-para fraction information of the hydrogen storage tank from the temperature sensor and the fraction analyzer and control the operation of the catalyst holder to adjust a contact area between the hydrogen and the catalyst.

22. The liquid hydrogen storage system of claim 21, wherein the temperature sensor comprises a plurality of temperature sensors spaced apart from each other by a certain distance in a height direction of the hydrogen storage tank, and
the controller is further configured to adjust the contact area of the catalyst so that an average temperature in the height direction of the hydrogen storage tank is maintained at 14 K to 80 K.

23. The liquid hydrogen storage system of claim 22, wherein the liquid hydrogen storage system is installed in a vessel on which a hydrogen storage tank storing liquid hydrogen is mounted, and
the controller is further configured to receive, from an operation system of the vessel, operation information including at least one of a number of days of ballast voyage, an average temperature of a mean top and bottom condition in liquefied natural gas (LNG) tank (ATR), an amount of fuel supply to a fuel cell, and a vent amount of hydrogen gas and adjust the contact area of the catalyst.

24. The liquid hydrogen storage system of claim 21, wherein the temperature control device induces a catalytic reaction to convert the para hydrogen into the ortho hydrogen according to a change in an internal temperature of the hydrogen storage tank.

25. The liquid hydrogen storage system of claim 21, wherein the catalyst holder is further configured such that as the internal temperature of the hydrogen storage tank increases, the exposure area of the catalyst is increased so as to promote the catalytic reaction to convert the para hydrogen into the ortho hydrogen.

26. The liquid hydrogen storage system of claim 25, wherein the catalyst holder is formed to surround at least a portion of the catalyst, comprises a plurality of pores formed to expose the catalyst to an outside, and comprises a shape memory alloy whose pore size is adjusted according to the internal temperature of the hydrogen storage tank.

27. The liquid hydrogen storage system of claim 26, wherein a size of the pore is smaller than a particle size of the catalyst.

28. The liquid hydrogen storage system of claim 25, wherein the catalyst holder comprises:
a porous member formed to surround at least a portion of the catalyst and comprising a plurality of pores formed to expose the catalyst to the outside; and
an opening/closing portion provided to surround an outside of the porous member and configured to operate to vary an area where the catalyst comes into contact with the outside according to the internal temperature of the hydrogen storage tank.

29. The liquid hydrogen storage system of claim 28, wherein the opening/closing portion comprises a shape memory alloy or a structure that is driven by an electric signal.

30. The liquid hydrogen storage system of claim 28, wherein a size of the pore is smaller than a particle size of the catalyst.

31. The liquid hydrogen storage system of claim 21, wherein the catalyst is iron oxide.
